(19) United States
(12) Patent Application Publication
(10) Pub. No.: US 2011/0174434 A1
(43) Pub. Date: Jul. 21, 2011

(54) Preparation of film coating of PLA biodegradable materials and its setup

(76) Inventor: Fu-Shih Hsiao, Nantou City (TW)

(21) Appl. No.: 12/007,810

(22) Filed: Jan. 15, 2008

(51) Int. Cl. B32B 37/02; B32B 37/10; B32B 37/14; B32B 37/06; B32B 37/08; B32B 38/18

(52) U.S. Cl. 156/244.17; 156/379.6

(57) ABSTRACT

A manufacturing method of coating film PLA biodegradable material and its setup using PLA biodegradable granule through drying machine to process water content before heating granule to molten on one hand and entering lamination head on the other hand through conveyer and squeezing out a thin film, then pushes lamination machine to fixed location and position lamination head between two rollers, than through lateral cylinder to control its displacement so that lamination head locates at center of two rollers, same time control rolling machine so that lamination point ascends to proper distance from outlet; while paper web or thin wood paper board surface heating through heater and enlarging pores, then using surface treatment so that pores are further enlarged to facilitate PLA thin film easy to coat film for providing fast lamination and increase yield and producing all kinds of paper containers and achieve natural degradation.

### BACKGROUND OF THE INVENTION

(a) Field of the Invention

The preparation of film coating PLA bio-degradable material and its setup of the present invention, particularly the application of PLA biodegradable granule through drying and heating process and then control of lamination machine to push into a fixed position for said lamination head locates between the two rollers of the rolling machine, then control the right and left displacement of said lamination machine for said laminating head to locate at the center location between said two rollers while at the same time control said rolling machine to push and ascend or descend so that the laminating point between two said rollers ascend to a proper distance from outlet of said lamination head, then according to the heater and surface processing machine to said paper web or thin wood paper board to engage surface drying and enlarging of pores so that said thin film lamination coating could cover on the paper web or thin wood paper board for fast lamination in order for producing paper container to achieve technology filed of natural degradation with environmental protection result.

(b) Description of the Prior Art

Paper product in general (such as paper cup, paper bowl, paper plate, paper box and paper lunch box, drink box, nonwoven cloth, and paper container, etc), in order for the food contained not to seep out, usually will coat a layer of PE film on the inside of the paper board of the paper product. However, said film often could not degrade naturally and create secondary damage to the environment. Therefore, a kind of PLA biodegradable material was subsequently developed. Producing container using said material not only could degrade naturally but also is non-toxic so as to achieve the effect of protecting environment. And also containing liquid or good for a short time will not have problem in degradation.

### SUMMARY OF THE INVENTION

### I. Problems to Resolve

1. As the price of said PLA biodegradable material is expensive, the container product used only once and threw away is a heavy burden to consumer and could not become prevalent.
2. As the amount of usage for producing container using PLA biodegradable material directly is quite high, the degree of wasteful is also high and therefore the cost could not be reduced.
3. If the PLA biodegradable material is coated directly onto said paper web, said material has water content and could not be easily laminated onto said paper web and could drop off easily, which is indeed a major drawback.

### II. Method of Resolution

1. The application of PLA biodegradable material of the present invention makes use of film lamination process to coat paper web or thin wood paper board not only could generate a thin PLA layer with degradable effect but also could benefit from matching of recycle of paper web or thin wood paper board and lower cost in order to achieve the effect of environmental protection.
2. The present invention makes use of PLA biodegradable granules to go through drying machine to process water content to certain standard before sending to screw rod conveyer machine to heat the PLA biodegradable granule to molten and press out a thin film then push the lamination machine to a fixed position and enable said lamination head to locate between the two rollers of rolling machine, then control the left and right displacement through a lateral cylinder for said lamination head to locate in the center of said two rollers on one hand, while at the same time control the push back hydraulic cylinder located at the bottom of said rolling machine, raise the lamination point between said two rollers to a proper distance from the outlet of said lamination head, at the same time when paper web or thin wood paper board after surface heating through heater and enlarging of pores, the surface treatment was performed by electro-shocking the coating film so that said pores are further enlarged to facilitate the easy of coating PLA thin film and for said thin film coating film or coating on the paper web or thin wood paper board easier to laminate quickly in order to provide the production of paper container to achieve the environmental effect of natural degradation.
3. The surface of paper web or thin wood paper board of coating film of the present invention can be made into paper cup, bowl, plate, lunch box, or thin wood paper board product into lunch box.

### BRIEF DESCRIPTION OF THE DRAWINGS

FIG. 1 is the block diagram of manufacturing flow of the present invention.

FIG. 2 is the diagram of coating film manufacturing setup of the present invention.

FIG. 3 is the illustration of the action of coating film manufacturing setup of the present invention.

FIG. 4 is the illustration of the production flow of the present invention.

### DETAILED DESCRIPTION OF THE PREFERRED EMBODIMENTS

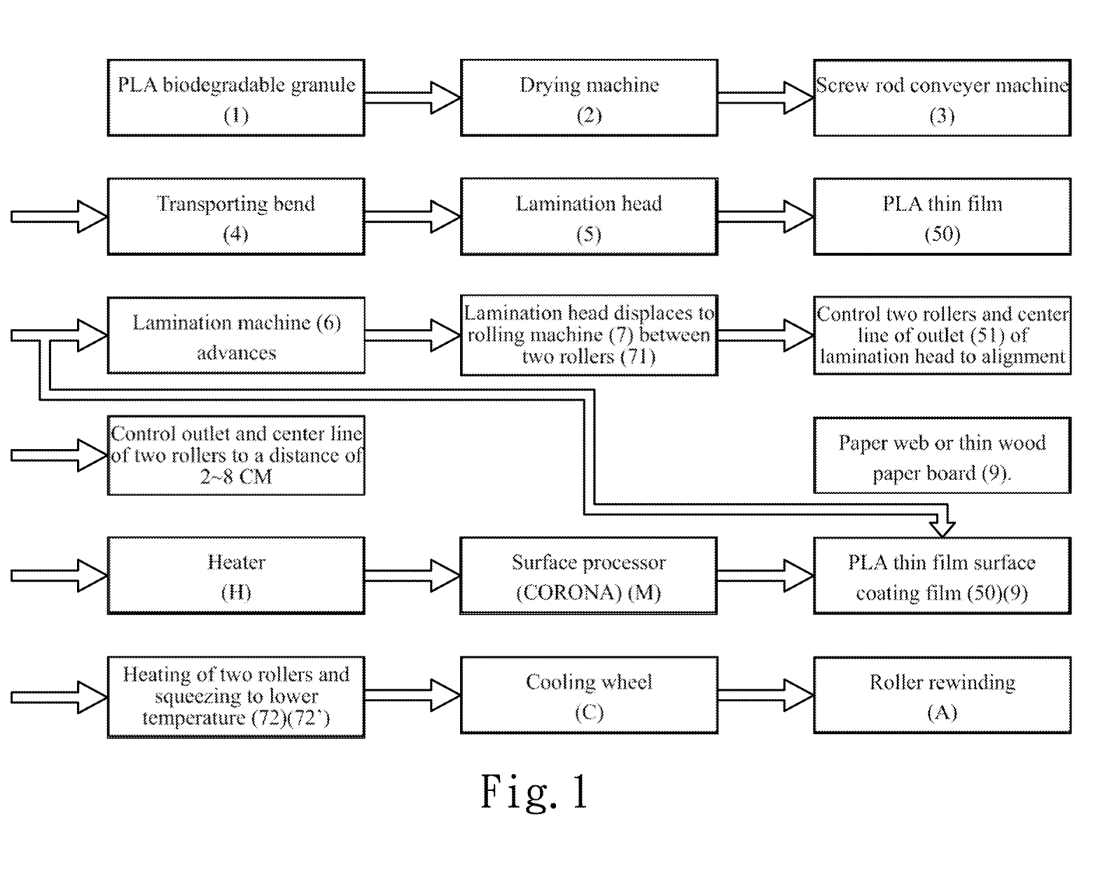

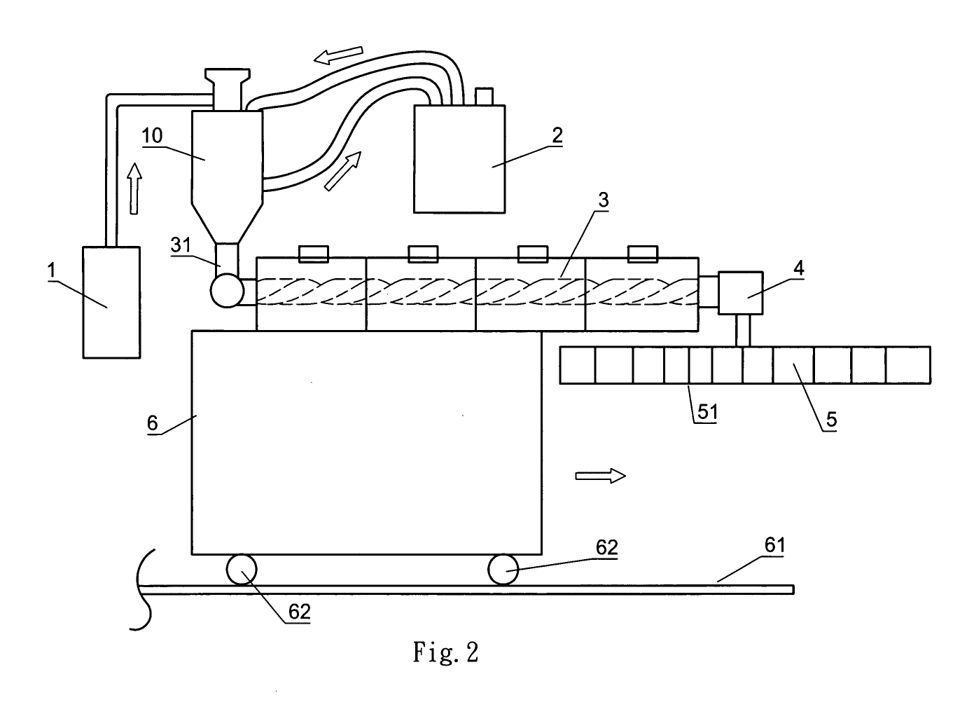

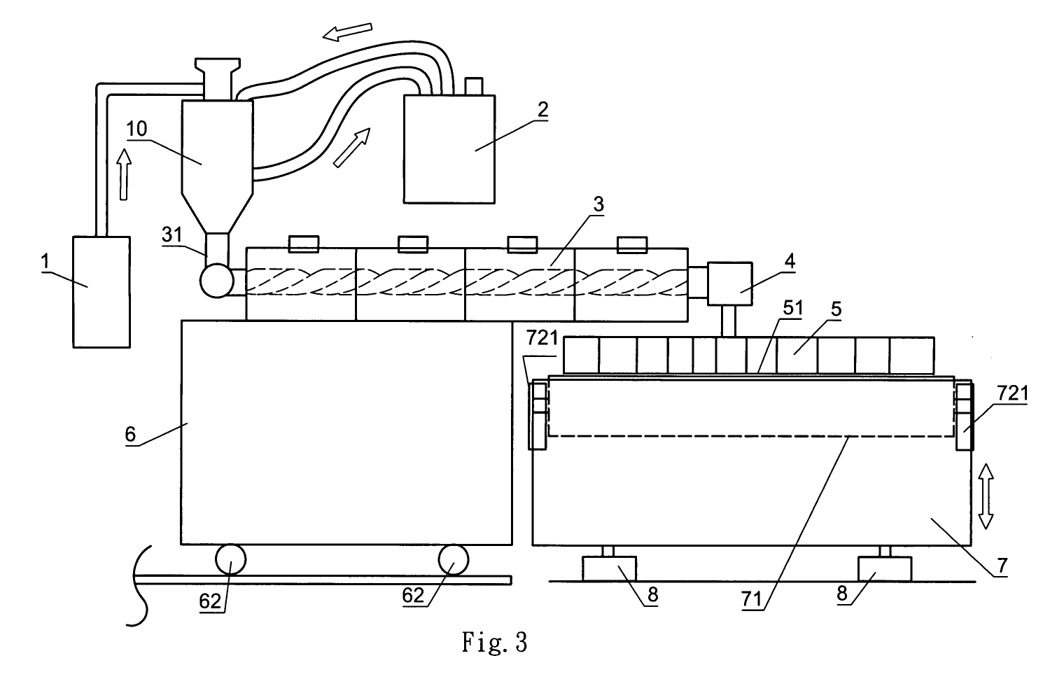

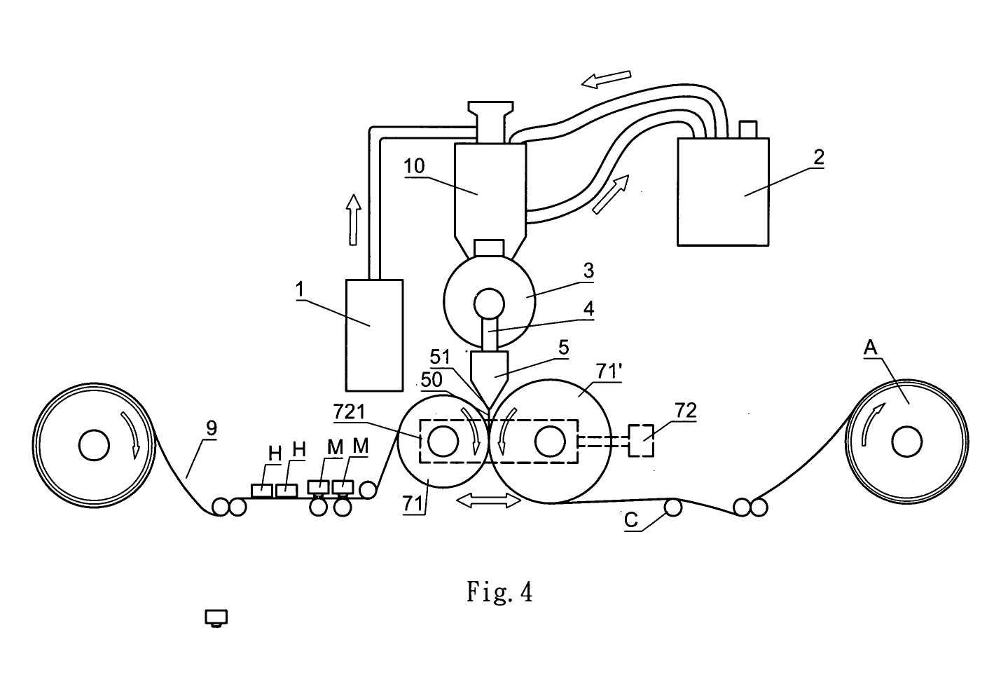

FIGS. 1, 2, & 4 show the illustrations of sending PLA biodegradable granule 1 into drying tank 10, wherein hot air is sent into said drying tank 10 through drying machine 2, and the water content of the PLA biodegradable granule 1 is recollected to drying machine 2 for processing to certain level of humidity before melting PLA biodegradable 1 granule by heating through screw rod conveyer machine 3 on one hand and sending into lamination head 5 through transporting bend 4, and pressing out a PLA thin film 50 (as shown in FIG. 2), and then push the lamination machine 6 to certain position (as shown in FIG. 3), and then enable said lamination head 5 position between the two rollers 71 of rolling machine 7, then through a lateral cylinder 72 control fixed sliding base 721 of said axis installed with said two rollers 71 for fine-tuning left or right displacement, so that said lamination head 5 position at the center line position between said two rollers 71, while control the top pushing cylinder 8 below said rolling machine 7 to ascend the lamination film center line to a proper distance from outlet 51 of said lamination head 5, at the same time paper web or thin wood paper board 9 through surface drying heater H and enlarging pores before using surface processing machine M to electro-shock said surface, so that said pore is further enlarged (as shown in FIG. 4), so that said PLA thin film 50 coating film onto paper web or thin wood paper board 9 for fast lamination (as shown in FIG. 4) in order for the manufacturing of paper container to achieve the environmental protection effect of natural degrading.

FIGS. 1, 2, and 4 shows the drying machine 2 stated above sending hot air at 50° C.˜90° C. to PLA biodegradable granule 1 so that water content of said PLA biodegradable granule 1 is reduced to about below 300 PPM, then deliver to between transporting bends 4 from outlet 31 through screw rod conveyer machine 3 by gradually reducing from 130° C. at about 20° C. rate to about 235° C., for PLA biodegradable material to distribute to lamination head 5 through screw rod conveyer machine 3 and pressed to form PLA thin film 50 as the best state; said already molten PLA biodegradable material 1 through transporting bend 4 entering lamination head 5, then, through heating of lamination head 5, a PLA thin film 50 is squeezed out; the lamination machine 6 stated above uses advancing rail 61 route to move advancing guide wheel 62 forward to the top of center line between the two rollers 71 of the rolling machine 7, then through the top pushing cylinder 8 below rolling machine 7 pushing upward for said center line to be below 8 cm distance from outlet 51 of lamination head 5, in order for PLA thin film 50 easier to combine with low density surface so as to improve the lamination effect of said PLA thin film 50 with said paper web or thin wood paper board 9.

Refer to FIGS. 1 and 4, wherein said paper web or thin wood paper board 9 before inputting for lamination uses heater H to undergo surface drying and enlarging of pores, then the surface processing machine (CORONA) M performs electro-shock to said surface at the power of 5 kw˜15 kw in order to improve the enlarging effect of surface pores, through PLA thin film 50 to paper web or thin wood paper board 9 surface coating film, through rubber roller 71 and metal roller 71′ using about 50˜70° C. rolling lamination and lowering of temperature in order to increase the lamination degree. Then through a cooling wheel C using about 18˜29° C. to lower the temperature of said paper web or thin wood paper board 9 already coated with PLA thin film 50 to the level for roller A to wind in order to make all kinds of containers such as paper cup, bowl, plate, lunch box, pack container, or lunch box made from thin wood paper board, in order to achieve the naturally degradable environmental protection effect, and further could provide the economic benefit of fast lamination and reduction of cost.

1. A coating film PLA biodegradable material manufacturing method, wherein the method comprises:
a. drying tank for placing PLA biodegradable granule;
b. sending hot air into said drying tank through drying machine, and recycle water content to drying machine for processing so that the PLA biodegradable granule reaches certain humidity level.
c. using screw rod conveyer machine to heat up PLA biodegradable granule to molten on one hand and entering lamination head through transporting bend on the other hand, and squeeze out a PLA thin film;
d. pushing lamination machine to a fixed position, and position said lamination head to between two rollers of rolling machine;
e. again through controlling of said axis the fixing base of two rollers installed for fine tuning of left or right displacement so that said lamination head is positioned at the center line location between said two rollers;
f. at the same time control the ascending of center line of coating film between said two rollers of said rolling machine to a proper distance from outlet of said lamination head;
g. said paper web or thin wood paper board before inputting for lamination, perform surface baking and enlarging pores through heater before electrical shock of surface through surface processing machine (CORONA) in order to increase the enlarging effect of surface pores;
h. after surface coating film through PLA thin film to paper web or thin wood paper board through lower temperature lamination of rubber roller and metal roller in order to increase lamination degree;
i. again, through an even lower temperature cooling wheel to reduce temperature of already coating PLA thin film paper web or thin wood paper board to level for roller rewinding, in order to provide manufacturing of all kinds of paper container such as paper cup, bowl, plate, lunch box, packing container or lunch box or container made of thin wood paper board in order to achieve naturally degradable environmental effect, and further to achieve the economic benefit of fast lamination and fast and lower cost.

2. A coating film PLA biodegradable material manufacturing method stated in claim 1 above, wherein said drying machine sends air using 50° C.˜90° C. hot air to PLA biodegradable granules so that the water content of said PLA biodegradable granules is reduced to below 300 PPM to facilitate heating to increase its temperature to about 190˜230° C., so that the PLA biodegradable material formed in PLA thin film delivered to lamination head through screw rod conveyer machine is in best condition.

3. A coating film PLA biodegradable material manufacturing method stated in claim 1 above, wherein said screw rod conveyer machine from inlet to transporting bend gradually increases from 130° C. at about 20° C. rate to about 235° C., so that said molten PLA thin film is easy to laminate with low density surface.

4. A coating film PLA biodegradable material manufacturing method stated in claim 1 above, wherein said lamination machine uses advancing rail route through advancing guide wheel to move forward to the top of the center line between two rollers of the rolling machine, then pushing rolling machine upward through the top pushing hydraulic cylinder below the rolling machine, so that said center line is within 8 cm from outlet of said lamination head, so PLA thin film is easier to laminate with low density surface in order to increase the lamination effect of said PLA thin film with said paper web or thin wood paper board.

5. A coating film PLA biodegradable material manufacturing method stated in claim 1 above, wherein after paper web or thin wood paper board laminates with PLA thin film, through rolling and lowering temperature at about 50˜70° C. of said rubber roller and metal roller in order to increase its lamination degree.

6. A coating film PLA biodegradable material manufacturing method stated in claim 1 above, wherein said cooling wheel reduce the temperature of paper web or thin wood paper board of the coated film PLA thin film at about 18˜29° C. to the extend for roller to rewind.

7. A coating film PLA biodegradable material manufacturing method stated in claim 1 above, wherein after paper web or thin wood paper board laminates with PLA thin film, could offer all kinds of paper containers such as paper cup, bowl, lunch box, packing container or lunch box made of thin wood paper board, in order to achieve the environmental protection effect of naturally degradation.

8. A coating film PLA biodegradable material setup, wherein said setup includes:
a drying tank, for storing PLA biodegradable granule;
a drying machine, for sending hot air into drying tank so that water content of said PLA biodegradable granule could be reduced to below required humidity;
a screw rod conveyer machine, for heating between the inlet of lower end of drying tank and transporting bend, so that said molten PLA biodegradable material enters lamination head through transporting bend;
a lamination head, for squeezing out a PLA thin film; and
a lamination machine, advances rail route through advancing guide wheel to move forward, so that said lamination head displaces to the top of between two rollers of rolling machine;
a lateral hydraulic cylinder, whereas pushing axis is installed with fixed sliding base for said two rollers;
a rolling machine, wherein the bottom is installed with a top pushing hydraulic cylinder for the rolling machine to push upward, so that said center line from outlet of said lamination head is at a distance of below 8 cm;
a heater, installed on the surface of paper web or thin wood paper board for performing drying and enlarging of surface pores;
a surface treatment machine, installed at the back of said heater and located on the surface of said paper web or thin wood paper board, through high voltage electrical shock in order to increase the enlarging effect of surface pores;
a cooling wheel, installed at the back of two rollers, for reducing the temperature of paper web or thin wood paper board after lamination to facilitate roller rewinding.

9. A coating film PLA biodegradable material setup as stated in claim 8 above, wherein said setup dryer machine delivers hot air at 50° C.˜90° C. to PLA biodegradable granule for the water content of said PLA biodegradable granule to reduce to below 300 PPM.

10. A coating film PLA biodegradable material setup as stated in claim 8 above, wherein said screw rod conveyer machine from inlet to transporting bend increases gradually from 130° C. at 20° C. rate to about below 235° C. is best.

11. A coating film PLA biodegradable material setup as stated in claim 8 above, wherein said top pushing hydraulic cylinder pushes rolling machine upward so that said center line is about below 8 cm from the outlet of said lamination head, so that the PLA thin film is easy to laminate with low density surface.

12. A coating film PLA biodegradable material setup as stated in claim 8 above, wherein the two rollers of said rolling machine is installed with a rubber roller and a metal roller, after mutual rolling the heating temperature is about 50˜70° C. in order to increase the lamination degree.

13. A coating film PLA biodegradable material setup as stated in claim 8 above, wherein said cooling wheel reduce the temperature of paper web or thin wood paper board of the already coated film PLA thin film at about 18˜29° C. to the extend for roller to rewind.
